(19) United States
(12) Patent Application Publication
(10) Pub. No.: US 2007/0294564 A1
(43) Pub. Date: Dec. 20, 2007

(54) High availability storage system

(76) Inventors: Tim Reddin, Galway (IE); Robert J. Souza, Windham, NH (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/411,851

(22) Filed: Apr. 27, 2006

(51) Int. Cl. G06F 11/00

(52) U.S. Cl. 714/6

(57) ABSTRACT

Methods and systems are described for a storage system including at least two controllers configured to handle write requests and a non-volatile cache connected to both controllers that stores data received from the controllers. The non-volatile cache is accessible by the first and second controllers using an interface technology permitting two or more communication paths between a particular active controller and the non-volatile cache to be aggregated to form a higher data rate communication path. Additionally, a plurality of storage devices are each connected using the interface technology to each controller for storing data received from the controllers.

### BACKGROUND

1. Field of the Invention

The present invention relates generally to storage systems, and more particularly, to methods and systems for high availability storage system.

2. Related Art

Modern, high availability, storage systems typically use redundancy for protection in the event of hardware and/or software failure. This is often achieved in current systems by employing multiple (typically two) controllers. For example, in one type of prior art system one controller is active and the second is in standby. In the event the active controller fails, the standby controller assumes control of the system.

Many high-availability storage systems also implement a storage strategy that involves using multiple magnetic storage devices. One such storage strategy is the Redundant Array of Inexpensive (or Independent) Disks (RAID) storage strategy that uses inexpensive disks (e.g., magnetic storage devices) in combination to achieve improved fault tolerance and performance. Because it takes longer to write information to magnetic storage devices than to Random Access Memory (RAM), such storage systems can introduce latency for write operations. In order to reduce this latency, controllers in conventional systems include a cache, which is typically non-volatile RAM (NVRAM). When the controller receives a write request, it first writes the information to the NVRAM. Then the controller signals to the entity requesting the write that the data is written. The controller then writes the data from the NVRAM to the magnetic storage devices. It should be noted that although this process was described with three sequential steps for simplification purposes, one of skill in the art would be aware that the steps need not be sequential. For example, data may begin being written to the magnetic storage devices at the same time that the data is being written to the cache.

FIG. 1 illustrates a simplified block diagram of a conventional storage system 104. Illustrative storage system 104 comprises two controllers 108 and 110, where one controller is designated the active controller 108 and the other, the standby controller 110. In normal non-fault operations, active controller 108 controls storage system 104 including the receipt of write requests from host 102 and the writing of data to storage disks 114 via Storage Area Network (SAN) interconnect block 112. Standby controller 110 remains on (hot) in normal operations, so that standby controller 110 is ready in the event active controller 108 fails, in which case standby controller 110 takes over control of storage system 104. Storage system 104 also includes an inter-controller link 120 for allowing communications between active controller 108 and standby controller 110. As noted above, storage disks 114 are typically standard magnetic storage disks in normal RAID applications. SAN interconnect blocks 106 and 112 typically include switches, such as fiber channel switches for transferring data between the illustrated block (i.e., active controller 108, storage disks 114, and standby controller 110, host 102, etc.).

In operation, host 102 generates a write request that it forwards to SAN interconnect block 106, which in turn forwards the write request to active controller 108. Active controller 108 then writes the data to its local cache 128, which is typically NVRAM. In addition, active controller 108 also communicates with standby controller 110 via intercontroller link 120 to ensure that the cache 130 of standby controller 110 includes a mirror copy of the information written to cache 128. This permits standby controller 110 to immediately take over control of storage system 104 in the event active controller 108 fails.

After the write data is written to cache 128, active controller 108 signals host 102 that the write is complete. Active controller 108 then writes the data to storage disks 114 via SAN interconnect block 112.

For standby controller 110 to be available to take over control of storage system 104 in the event of failure of active controller 108, it is necessary that the caches 128 and 130 of controllers 108 and 110, respectively, be maintained in a coherent fashion. This requires intercontroller link 120 to be a high speed link, which can increase the cost of the storage system. Further, these systems typically require a custom design to deliver adequate performance, which adds to development cost and time to market. Further, these designs also often have to change with advances in technology further increasing the costs of these devices

Other conventional systems employ two controllers, an active controller and a standby controller, and a single NVRAM cache accessible to both controllers. The active controller in non-fault conditions controls all writes to the NVRAM and the storage disks. Because the standby controller is typically inactive in non-fault conditions and has access to the NVRAM, the active controller need not be concerned with coherency. When the active controller fails, the standby controller becomes active, writes all data from the NVRAM to the storage disks, and then takes over full control of data writes. This system, however, as with the above-discussed system, has the drawback that it only provides a single controller's bandwidth—but at the cost of two controllers.

Additionally, other conventional systems employ two or more active controllers. In one such system, each active controller is responsible for a subset of the storage devices. This type of system is referred to an asymmetric system. While, in other systems, each active controller may write to any storage device in the system. This type of system is referred to as a symmetric system. However, these prior asymmetric and symmetric systems, like the above-described active-standby configuration of FIG. 1, required customized solutions to deliver adequate performance. For example, these systems often required a customized intercontroller link between the active controllers for maintaining coherency of their respective caches.

### SUMMARY

In accordance with the invention, methods and systems are provided for receiving a write request regarding data to be stored by a storage system comprising a plurality of storage devices, transferring the write request to a selected one or a plurality of active controllers, storing, by the selected controller, the data in a non-volatile cache simultaneously accessible by both the selected controller and at least a second active controller of the plurality of active controllers, wherein the non-volatile cache is accessible by the active controllers using an interface technology permitting two or more communication paths between a particular active controller and the non-volatile cache to be aggregated to form a higher data rate communication path, and storing, by the selected controller, the data in one or more of the storage devices, wherein the storage devices are connected to both the selected controller and one or more other active controllers.

In another aspect, methods and systems are provided for a system including a first controller configured to actively handle write requests, a second controller configured to perform at least one of the following while the first controller is actively handling write requests: actively handle write requests or operate in a standby mode, a non-volatile cache connected to both the first and second controllers and configured to store data received from the first and second controllers, wherein the non-volatile cache is accessible by the active controllers using an interface technology permitting two or more communication paths between a particular active controller and the non-volatile cache to be aggregated to form a higher data rate communication path, and a plurality of storage devices each connected to both the first and second controllers, and wherein the plurality of storage devices are configured to store data received from the first and second controllers.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the claimed invention.

The accompanying drawings, which are incorporated in and constitute a part of this specification, illustrate one embodiment of the invention and together with the description, serve to explain the principles of the invention.

### BRIEF DESCRIPTION OF THE DRAWINGS

FIG. 1 illustrates a simplified block diagram of a conventional storage system;

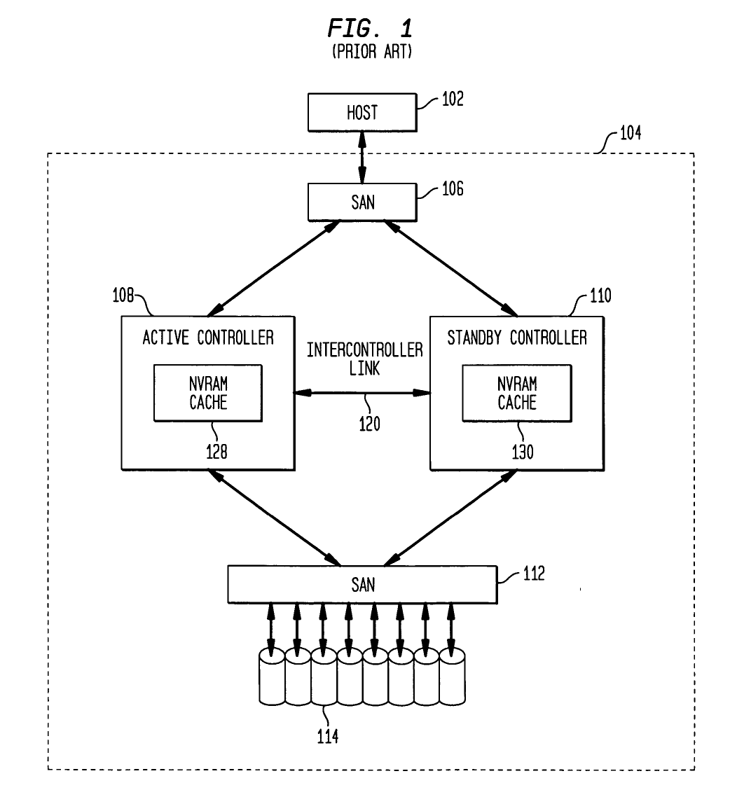

FIG. 2 illustrates a simplified diagram of a storage system, in accordance with an embodiment of the invention;

FIG. 3 illustrates an exemplary flow chart of a method for handling write requests, in accordance with an embodiment of the invention;

FIG. 4 illustrates an exemplary method for fault handling in the event of controller failure, in accordance with and embodiment of the invention.

Reference will now be made in detail to exemplary embodiments of the present invention, an example of which is illustrated in the accompanying drawings. Wherever possible, the same reference numbers will be used throughout the drawings to refer to the same or like parts.

### DETAILED DESCRIPTION

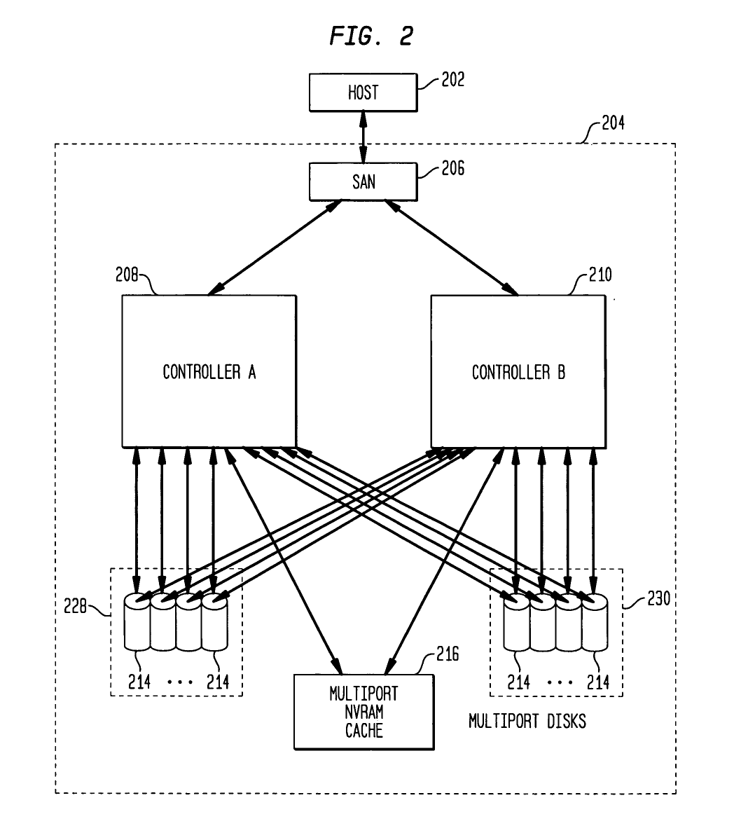

FIG. 2 illustrates a simplified block diagram of a storage system in accordance with embodiments of the present invention. As illustrated, a host 202 is connected to a storage system 204. Host 202 may be any type of computer capable of issuing write requests (e.g., requests to store data). Storage system 204, as illustrated, includes a SAN interconnect block 206, two controllers 208 and 210, a plurality of storage disks 214, and a multiport cache 216.

Storage disks 214 may be any type of storage device now or later developed, such as, for example, magnetic storage devices commonly used in RAID storage systems. Further, storage disks 214 may be arranged in a manner typical with RAID storage systems. Storage disks 214 also may include multiple logical or physical ports for connecting to other devices. For example, storage disks 214 may include a single physical Small Computer System Interface (SCSI) port that is capable of providing multiple logical ports. Or, for example, storage disks 214 may include multiple Serial Attached SCSI (SAS) ports. For explanatory purposes, the presently described embodiments will be described with reference to SAS ports, although in other embodiments, other current or future developed multiport interface technologies may be used. Additionally, in the embodiments described herein, SAS lanes between controllers (208 and 210) and storage disks 214 may be aggregated to improve data transfer rates between controllers 208 and 210 and storage disks 214. For example, two or more SAS lanes between a controller (e.g., controller 208 or 210) and a storage disk 214 may be aggregated to form a higher data rate SAS lane between the controller (208 or 210) and the storage disk 214. An SAS lane refers to a communication path between a SAS port on one device and a SAS port on another device.

SAN interconnect block 206 may include, for example, switches for directing write requests received from host 202 to one of the particular controllers (208 or 210). For example, SAN interconnect block 206 may include a switch fabric (not shown) and/or a control processor (not shown) for controlling the switch fabric. This switch fabric may be any type of switch fabric, such as an IP switch fabric, an FDDI switch fabric, an ATM switch fabric, an Ethernet switch fabric, an OC-x type switch fabric, or a Fibre channel switch fabric.

The control processor (not shown) of SAN interconnect block 206 may, in addition to controlling the switch fabric, also be capable of monitoring the status of each controller 208 and 210 and detecting whether controllers 208 or 210 become faulty. For example, controller 208 or 210 may fail completely or may become sufficiently faulty (e.g., generating errors) that the control processor (not shown) of SAN interconnect block 206 may determine to take a controller out of service. Additionally, in other embodiments, a separate storage system controller (not shown) may be connected to each controller that is capable of monitoring the controllers 208 and 210 for fault detection purpose. Or, in yet another embodiment, controllers 208 and 210 may include a processor capable of monitoring the other controllers for fault detection purposes. A further description of exemplary methods and systems for handling controller failure is presented below.

Controllers 208 and 210 preferably include a processor and other circuitry such as interfaces for implementing a storage strategy, such as a RAID level strategy. Also, as shown, controllers 208 and 210 are each connected to each and every storage device 214. In this example, controller 208 and 210's interfaces for connecting controllers 208 and 210 with storage disks 214 preferably implement a multiport interface technology, such as the SAS interface technology discussed above.

Although connected to each and every storage device 214, controller 208 and 210 are each, in this embodiment, only responsible, during normal non-fault operations for handling write requests to a subset of the storage disks 214, i.e., subset 228 and 230, respectively. That is, in normal operations, both controllers 208 and 210 are active and service write requests such that each controller 208 and 210 handles writes to a different subset (228 and 230, respectively) of storage disks. This permits the write requests to be distributed across multiple controllers and helps to improve the storage systems' capacity and speed in handling write requests. As used herein, the term “active controller” refers to a controller that is available for handling write requests, as opposed to a standby controller that, although hot, is not available to handle write requests until failure of the active controller. A further description of an exemplary method for handling write requests is provided below.

Controller 208 and 210 are also each connected to multiport cache 216. Multiport cache 216 is preferably a NVRAM type device, such as battery backed-up RAM, EEPROM chips, a combination thereof, etc. Or, for example, multiport cache 216 may be a high speed solid state disk or a sufficiently fast commodity solid state disk using, for example, a future developed FLASH type technology that provides adequate speed.

Multiport cache 216 preferably provides multiple physical and/or logical ports that allow multiport cache 216 to connect to both controller 208 and 210. As with storage disks 214, any type of appropriate interface technology may be used, and, for explanatory purposes, the presently described embodiments will be described with reference to SAS ports. Further, SAS communication paths (also known as “SAS lanes”) between the controllers (208 and 210) and multiport cache 216 may be aggregated to improve data transfer rates. Further, although in this embodiment controllers 208 and 210 are directly connected to storage disks 214 and multiport cache 216, in other embodiments these connections may be direct connections or, for example, may be via other devices, such as, for example, switches, relays, etc.

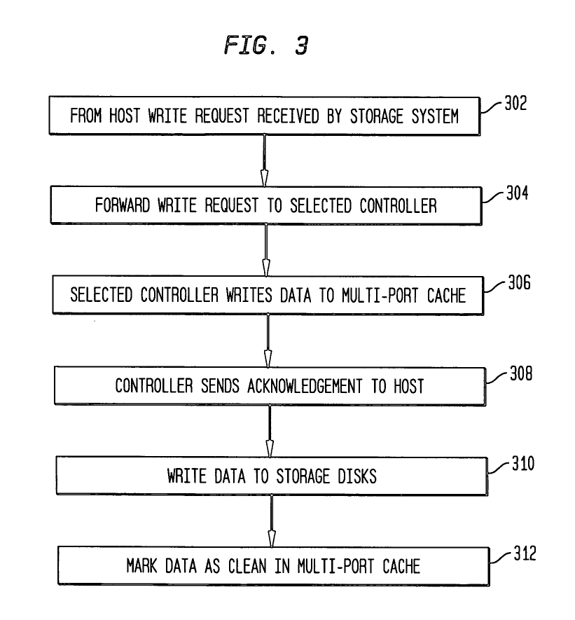

FIG. 3 illustrates an exemplary flow chart of a method for handling write requests, in accordance with one embodiment of the present invention. FIG. 3 will be described with reference to the exemplary system described above with reference to FIG. 2. Host 202 initiates a write request and sends it to storage device 204, where it is received by SAN interconnect block 206 at block 302.

SAN interconnect block 206 then analyzes the received write request and forwards it to either controller 208 or 210 at block 304. Various strategies may be implemented in SAN interconnect block 206 to determine which controller is to handle the received write request. For example, SAN interconnect block 206 may determine which controller is less busy and forward the write request to that controller. Or, for example, SAN interconnect block 206 may analyze the data and depending on the type of data determine which subset of storage disks (228 or 230) is to store the information and forward the write request to the controller tasked with controlling that storage disk subset. For exemplary purposes, in this example, the write request is forwarded to controller 208.

Controller 208 then writes the data to multiport cache 216 at block 306. For example, multiport cache 216 may be partitioned so that half of it is available to controller 208 and the other half available to controller 210. In such an example, the data would be written to the partition of multiport cache 216 allocated to controller 208. It should be noted that this is but one example, and in other embodiment, other mechanisms may be implemented for allowing multiport cache 216 to be shared by controllers 208 and 210.

Once the data is written to multiport cache 216, controller 208 may send an acknowledgement to host 202 indicating that the write is completed at block 308. Simultaneously or subsequent to the data being written to multiport cache 216, controller 208 also writes the data to storage disks 214 belonging to subset 228 at block 310. It should be noted that although FIG. 3 illustrates that the data is written to storage disks 214 subsequent to writing of the data to multiport cache 216, as mentioned above the data may be written simultaneous to the writing of data to multiport cache 216. Because multiport cache 216 is preferably NVRAM, data can be written faster to multiport cache 216 than to storage disks 214, and as such the acknowledgement that the write is complete will often be sent to host 202 prior to completion of the data write to storage disks 214.

Any appropriate mechanism may be used by controller 208 in writing the data to storage disks 214. For example, controller 208 in conjunction with storage disks 214 of subset 228 may implement a RAID storage strategy, where, for example, the data and/or parity information is written to a particular Logical Unit Number (LUN) beginning at a particular LUN offset specified by controller 208. RAID along with LUNs and LUN offsets are well known to those of skill in the art, and as such, are not described further herein.

After the data is written to storage disks 214, the controller 208 marks the data in the multiport cache 216 as clean at block 310. This allows the data to be written over or erased from multiport cache 216. The data write process is then completed and the controller and multiport cache 216 resources may be available for handling new write requests. Further, although this embodiment only describes the controller 208 handling one write request, it should be understood that controller 208, as in typical RAID systems, may handle multiple write requests at the same time. Additionally, as discussed above, both controllers 208 and 210 may be active such that the load is distributed across the controllers. Thus, both controllers 208 and 210 may simultaneously handle write requests. Further, because multiport cache 216 is connected to both controller 208 and 210, and each controller 208 and 210 is allocated a different partition of multiport cache 216, in certain embodiments, both controllers 208 and 210 may simultaneously write data to multiport cache 216.

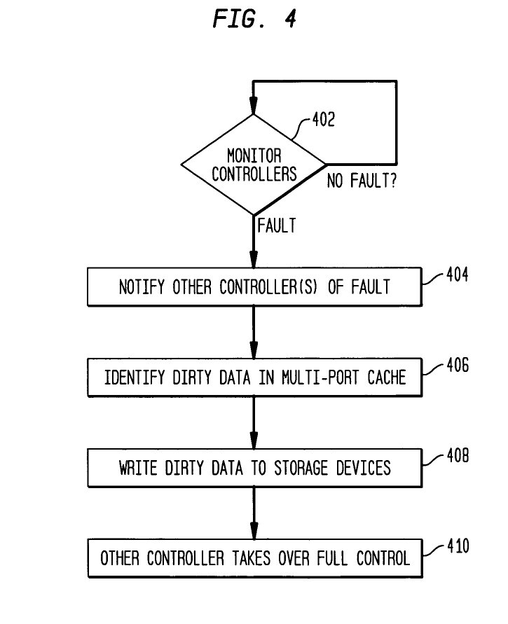

FIG. 4 illustrates an exemplary method for fault handling in the event of controller failure. This method will be described with reference to FIG. 2. A control processor (not shown) of SAN interconnect block 206 monitors the status of controllers 208 and 210 at block 402. In the event of failure of a controller (208 or 210), the control processor (not shown) of SAN interconnect block 206 notifies the other controller (208 or 210) at block 404. For explanatory purposes, in this example, controller 208 fails and controller 210 is notified of the failure so that it may take over operations of controller 208. Further, as noted above, although this embodiment is described with reference to a control processor (not shown) of SAN interconnect block 206 monitoring the status of controllers 208 and 210, in other embodiments, for example, a separate storage system controller (not shown) or the controllers 208 and 210 themselves may monitor the status of the controllers.

Controller 210 then accesses multiport cache 216 and identifies each set of “dirty data” written by controller 208 at block 406. “Dirty data” is data that was written to multiport cache 216 for which controller 208 sent an acknowledgement to host 202 that the write was complete, but has not yet been marked as clean. That, is controller 208 has either not yet completed writing the data to storage disks 214 of subset 228 or it was written but not yet identified as clean. After identifying the “dirty data,” controller 210 then reads the data and writes it to storage disks 214 at block 408. Controller 210 may, for example, write this data to storage disks 214 of subset 228 as controller 208 intended. Or, for example, controller 210 may no longer distinguish between storage disk subsets 228 and 230 and instead write the data to any of the storage disks 214 according to the storage strategy being implemented (e.g., a RAID strategy).

Controller 210 then takes over full control of storage operations and SAN interconnect block 206 forwards all write requests to controller 208 at block 410. Although FIG. 4 illustrates SAN interconnect block 206 forwarding all write requests to controller 210 after it writes the “dirty data” to storage disks 214, it should be understood that in other examples, SAN interconnect block 206 may start forwarding all write requests to controller 210 immediately after it detects a failure of controller 208. Additionally, although in this example, controller 208 fails, in other examples, controller 210 may fail and controller 208 may take over write operations for storage system 204.

Further, in yet other embodiments, 3 or more controllers may be used without departing from the invention. In such embodiments, some or all controllers may be active and available for handling write requests. This may be used to, for example, distribute the load of write requests across all active controllers. In the event of a fault with one of the active controllers, one or more of the active controllers may then take over control of the faulty controller's responsibilities, including writing its dirty data to the storage devices, such as described above. Or, in other examples, the load of the faulty controller may be distributed across all remaining active controllers. Or, in yet another embodiment, a system may employ both multiple active controllers and one or more standby controllers that are capable of taking over the responsibilities of a faulty controller.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method comprising:
receiving a write request regarding data to be stored by a storage system comprising a plurality of storage devices;
transferring the write request to a selected one of a plurality of active controllers;
storing, by the selected controller, the data in a non-volatile cache simultaneously accessible by both the selected controller and at least a second active controller of the plurality of active controllers, wherein the non-volatile cache is accessible by the active controllers using an interface technology permitting two or more communication paths between a particular active controller and the non-volatile cache to be aggregated to form a higher data rate communication path; and
storing, by the selected controller, the data in one or more of the storage devices, wherein the storage devices are connected to both the selected controller and one or more other active controllers using the interface technology.

2. The method of claim 1, further comprising:
detecting a fault with the selected controller;
reading, by the second controller, data written to the non-volatile cache by the selected controller; and
storing, by the second controller, the data read from the non-volatile cache.

3. The method of claim 1, further comprising:
forwarding, to an entity initiating the write request, an acknowledgment indicating that the write request is completed in response to the data being stored in the non-volatile cache.

4. The method of claim 1, further comprising:
marking the data stored in the non-volatile cache as clean in response to the data being stored in the storage devices.

5. The method of claim 1, wherein the non-volatile cache is non-volatile random access memory (RAM).

6. The method of claim 1, wherein the storage devices are non-volatile storage devices.

7. The method of claim 1, wherein the interface technology is a Serial Attached Small Computer System Interface (SAS) interface technology.

8. A storage system comprising:
a first controller configured to actively handle write requests regarding data to be stored by the storage system;
a second controller configured to perform at least one of the following while the first controller is actively handling write requests: actively handle write requests or operate in a standby mode;
an interconnect configured to transfer write requests to the first and second controllers;
a non-volatile cache connected to both the first and second controllers and configured to store data received from the first and second controllers to be stored by the storage system, wherein the non-volatile cache is accessible by the first and second controllers using an interface technology permitting two or more communication paths between a particular active controller and the non-volatile cache to be aggregated to form a higher data rate communication path; and
a plurality of storage devices each connected to both the first and second controllers using the interface technology, and wherein the plurality of storage devices are configured to store data received from the first and second controllers.

9. The system of claim 8, wherein the second controller comprises one or more processors configured to detect faults with the first controller, and, in response to detection of a fault with the first controller, read data written to the non-volatile cache by the first controller; and store the data read from the non-volatile cache in the storage devices.

10. The system of claim 8, wherein the first controller is configured to forward, to an entity initiating the write request, an acknowledgment indicating that the write request is completed in response to the data being stored in the non-volatile cache.

11. The system of claim 8, wherein the first controller is configured to mark the data stored in the non-volatile cache as clean in response to the data being stored in the storage devices.

12. The system of claim 8, wherein the non-volatile cache is non-volatile random access memory (RAM).

13. The system of claim 8, wherein the storage devices are non-volatile storage devices.

14. The system of claim 8, wherein the interface technology is a Serial Attached Small Computer System Interface (SAS) interface technology.

15. A system comprising:
means for receiving a write request regarding data to be stored by a storage system comprising a plurality of storage devices;
a plurality of means for storing the data in a non-volatile cache and for storing the data in one or more of the storage devices;
means for selecting one of the means for storing to handle the write request; and
means for transferring the write request to the selected means for storing;
wherein the non-volatile cache is simultaneously connected to a plurality of the means for storing and the non-volatile cache is accessible by the means for storing using an interface technology permitting two or more communication paths between a particular means for storing and the non-volatile cache to be aggregated to form a higher data rate communication path;
wherein at least one of the storage devices is simultaneously connected to a plurality of the means for storing using the interface technology; and
wherein at least two of the means for storing are simultaneously available to handle write requests.

16. The system of claim 15, wherein at least one means for storing comprises:
means for detecting a fault with the selected means for storing;
means for reading data written to the non-volatile cache by the selected means for storing; and
means for storing, the data read from the non-volatile cache.

17. The system of claim 15, further comprising:
means for forwarding, to an entity initiating the write request, an acknowledgment indicating that the write request is completed in response to the data being stored in the non-volatile cache.

18. The system of claim 15, further comprising:
means for marking the data stored in the non-volatile cache as clean in response to the data being stored in the storage devices.

19. The system of claim 15, wherein the non-volatile cache is non-volatile random access memory (RAM).

20. The system of claim 15, wherein the storage devices are non-volatile storage devices.

21. The system of claim 15, wherein the interface technology is a Serial Attached Small Computer System Interface (SAS) interface technology.
